(19) United States
(12) Patent Application Publication
(10) Pub. No.: US 2008/0173484 A1
(43) Pub. Date: Jul. 24, 2008

(54) Drive Unit and Vehicle Including the Same

(75) Inventors: Atsushi Umemura, Aichi-ken (JP); Tatsuhiko Mizutani, Aichi-ken (JP); Eiji Yanagida, Aichi-ken (JP); Keiji Takizawa, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI, AICHI-KEN (JP)

(21) Appl. No.: 11/885,757

(22) PCT Filed: Mar. 14, 2006
(86) PCT No.: PCT/IB06/00562

§ 371 Date: Sep. 6, 2007

(30) Foreign Application Priority Data
Mar. 15, 2005 (JP) 2005-072960

(51) Int. Cl. B60K 6/00; H02K 7/116; B60K 1/02

(52) U.S. Cl. 180/65.2; 310/112; 180/65.1

(57) ABSTRACT

A first motor and a second motor are housed in a case with a power split-integration mechanism and a reduction gear provided therebetween. Each of the first motor and the second motor is assembled from a stator formed by stacking stator members, which are made of the same material which have the same structure and which have the same diameter, and a rotor formed by stacking rotor members which are made of the same material which have the same structure and which have the same diameter such that the thickness of the stator and the rotor corresponds to the power that needs to be output from the motor. Thus, the variety of the components constituting the first motor and the second motor can be reduced, and the efficiency in the assembly and production of the first motor and the second motor can be improved.

### INCORPORATION BY REFERENCE

The disclosure of Japanese Patent Application No. 2005-072960 filed on Mar. 15, 2005, including the specification, drawings and abstract is incorporated herein by reference in its entirety.

### BACKGROUND OF THE INVENTION

1. Field of the Invention

The invention relates generally to a drive unit and a vehicle including the same, and, more specifically, to a drive unit that includes multiple rotary electric devices that are used to output different amounts of power, and a vehicle including such drive unit.

2. Description of the Related Art Japanese Patent Application Publication No. JP-A-2000-102108 describes a drive unit that includes an engine and two rotary electric devices. In this type of drive unit, one of the two rotary electric devices serves mainly as a generator, and the other rotary electric device serves mainly as an electric motor.

As described above, the multiple rotary electric devices are used for different purposes, and, thus have different features. Therefore, distinct stators and rotors that are suitable for the function of each rotary electric device must be selected. Accordingly, each rotary electric device requires components that differ from those of the other rotary electric devices, and a variety of components need to be prepared to assemble the multiple rotary electric devices. As a result, the variety of components increases, reducing the efficiency in the assembly and production of the rotary electric devices.

### SUMMARY OF THE INVENTION

A drive unit and a vehicle including such drive unit are configured according to the invention to reduce the variety of components constituting rotary electric devices (an electric motor and/or a generator) that output different amounts of power, and to improve efficiency in the assembly and production of the rotary electric devices.

A first aspect of the invention relates to a drive unit including multiple rotary electric devices that are used to output different amounts of power. Part of the configurations of at least two of the multiple rotary electric devices is made according to the same design specifications.

In the drive unit according to the first aspect, part of the configurations of at least two of the multiple rotary electric devices is made according to the same design specifications. As a result, the variety of the components constituting the multiple rotary electric devices can be reduced, and the efficiency in the assembly and production of the rotary electric devices can be improved.

In the drive unit according to the first aspect, each of the rotary electric devices may include a stator and a rotor both of which are formed by stacking multiple stator members and rotor members, respectively, having the same diameter. In addition, the multiple stator and rotor members may, respectively, be made of the same material and have the same structure. Because each of the multiple rotary electric devices can be assembled using shared stator members and rotor members, which are, respectively, made of the same material and have the same structure, the variety of components constituting the multiple rotary electric devices can be reduced. In addition, because the same members are produced in large numbers, the members can be produced with high accuracy.

In the drive unit according to the first aspect, although the rotary electric devices may share the stator members and the rotor members, that, respectively, have the same diameter, structure, and material composition, each rotary electric device may differ in the number of the stator members and the number of the rotor members. Thus, the rotary electric devices output the different amounts of power. The rotary electric devices can output different amounts of power due to the difference in the number of the stator members and the number of the rotor members included therein.

In the drive unit according to the first aspect, at least two of the rotary electric devices may be housed in a single-piece case. Because the multiple rotary electric devices are housed in the single-piece case, the structure of the case can be simplified in contrast to the housing of multiple rotary electric devices that do not share the same main configurations in the single-piece case.

A second aspect of the invention relates to a vehicle that includes the drive unit according to the first aspect, that is, the drive unit including the multiple rotary electric devices that output different amounts of power, wherein part of the configurations of at least two of the multiple rotary electric devices is made according to the same design specifications.

The vehicle according to the second aspect includes the drive unit according to the first aspect. Accordingly, the vehicle according to the second aspect produces the same effects as those produced by the drive unit according to the first aspect. For example, with the vehicle according to the second aspect, the variety of the components constituting the multiple rotary electric devices can be reduced, and the efficiency in the assembly and production of the rotary electric devices can be improved.

In the vehicle according to the second aspect, the rotary electric devices may include a first rotary electric device that is used to output power to a first axle and a second rotary electric device that is used to output power to a second axle.

The drive unit according to the first aspect may further include tri-axial power transfer means that is connected to three shafts, which are the input shaft that can receive and output power, the drive shaft that can output power, and the rotating shaft. The tri-axial power transfer means outputs power, based on the power input in and output from two of the three shafts, to the other shaft. The rotary electric devices include the first rotary electric device that inputs power in the rotating shaft and the second rotary electric device that inputs power in the drive shaft. In addition, the tri-axial power transfer means may be provided between the first rotary electric device and the second rotary electric device, and the tri-axial power transfer means, the first rotary electric device, and the second rotary electric device may be housed in a single-piece case. Thus, the drive unit can be made compact, and can be easily mounted, for example, in the vehicle. In addition, the second rotary electric device may be connected to the drive shaft via a reduction gear, and the reduction gear may be provided between the tri-axial power transfer means and the second rotary electric device. In this case, examples of the “reduction gear” include a reduction gear that can change the shift speed, and another reduction gear and a speed-up gear that do not change the shift speed.

A third aspect of the invention relates to a vehicle including an internal combustion engine, and the drive unit according to the first aspect further comprising the three-shaft power transfer means. According to this third aspect, the output shaft of the internal combustion engine is connected to the input shaft, and the axle is connected to the drive shaft. In addition, the drive unit includes multiple rotary electric devices that output different amounts of power, and part of the configurations of at least two of the multiple rotary electric devices is made according to the same design. The drive unit may further include the tri-axial power transfer means described above.

The vehicle according to the third aspect includes the drive unit according to the first aspect that includes the three-shaft power transfer means. Accordingly, the vehicle according to the third aspect produces the same effects as those produced by the drive unit according to the first aspect further including the three-shaft power transfer means. For example, with the vehicle according to the third aspect, the variety of the components constituting the multiple rotary electric devices can be reduced. This improves efficiency in the assembly and production of the rotary electric devices. Accordingly, the drive unit can also be made compact such that it can be easily mounted in the vehicle.

The vehicle according the third aspect may further include a third rotary electric device in which part of the configurations is made according to the same design specifications as those of the first and second rotary electric devices and which is used to output power to an axle different from the axle connected to the drive shaft. In addition, the rotary electric devices may be two of any of the first, second, and third rotary electric devices.

### BRIEF DESCRIPTION OF THE DRAWINGS

The features, advantages thereof, and technical and industrial significance of this invention will be better understood by reading the following detailed description of example embodiments of the invention, when considered in connection with the accompanying drawings, in which:

FIG. 1 schematically illustrates the configuration of a hybrid vehicle 20 including a drive unit according to an embodiment of the invention;

FIG. 2 illustrates an example of the configuration of the drive unit according to the embodiment;

FIG. 3 schematically illustrates the configuration of a stator member 92;

FIG. 4 schematically illustrates the configuration of a rotor member 94;

FIG. 5 illustrates a graph showing an example of the output features of motors MG1 and MG2 according to the embodiment;

FIG. 6 schematically illustrates the configuration of a hybrid vehicle 120 according to a modified example of the embodiment; and

FIG. 7 schematically illustrates the configuration of a vehicle 220 according to another modified example of the embodiment.

### DETAILED DESCRIPTION OF THE EXAMPLE EMBODIMENTS

In the following description and the accompanying drawings, the present invention will be described in more detail in terms of example embodiments.

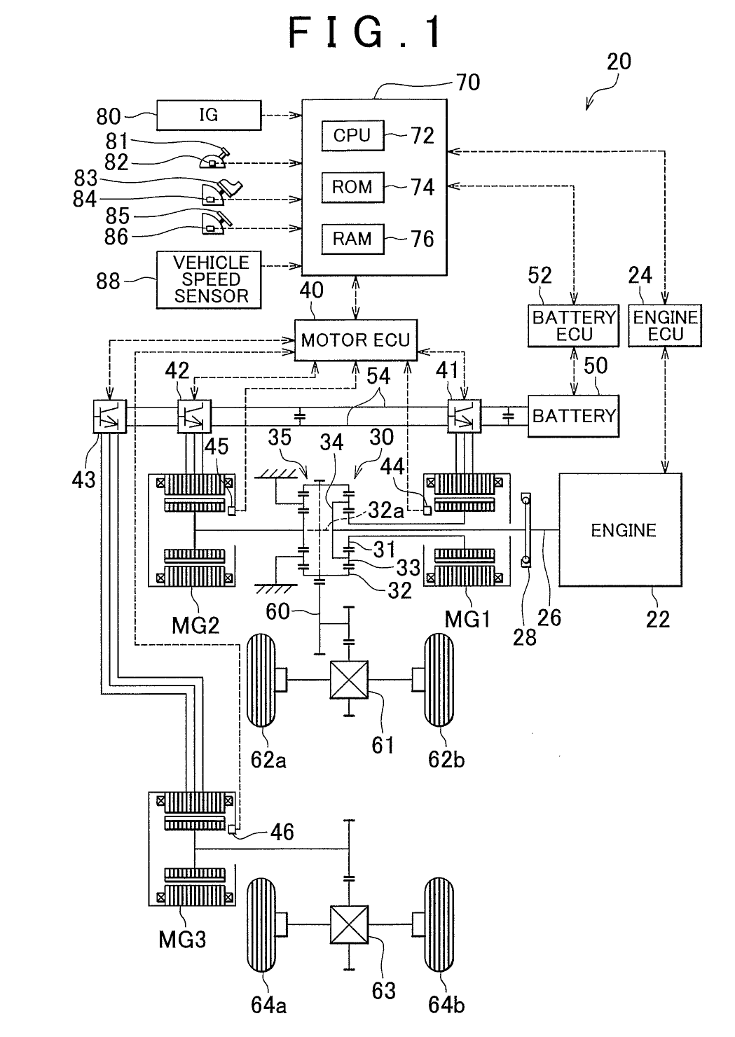

FIG. 1 schematically illustrates the configuration of a hybrid vehicle 20 including a drive unit according to an embodiment of the invention. As shown in FIG. 1, the hybrid vehicle 20 includes an engine 22; a planetary gear set 30; a motor MG1; a motor MG2; a motor MG3; and an electronic control unit 70 for a hybrid vehicle (hereinafter, simply referred to as a “hybrid ECU 70”). An electronic control unit 24 for an engine (hereinafter, simply referred to as an “engine ECU 24”) performs the operation controls of the engine 22 such as fuel injection control, ignition control and intake air amount adjusting control. A carrier 34 of the planetary gear set 30, which rotates pinions 33, is connected to a crankshaft 26 serving as the output shaft of the engine 22 via a damper 28, and a ring gear 32 of the planetary gear set 30 is connected to the axle of front wheels 62a and 62b via a coupling gear 62 and a differential gear unit 61. The motor MG1 is connected to a sun gear 31 of the planetary gear set 30, and can generate electric power. The motor MG2 is connected to the ring gear 32 of the planetary gear set 30 via a reduction gear 35 formed of a planetary gear set. The motor MG3 is connected to the axle of rear wheels 64a and 64b via a differential gear unit 63. The hybrid ECU 70 controls the entirety of the hybrid vehicle 20

Each of the motors MG1, MG2 and MG3 is a known synchronous generator motor that can serve as a generator and that can also serve as an electric motor. The motors MG1, MG2 and MG3 are supplied with electric power from a battery 50 that is controlled by an electronic control unit 52 for a battery (hereinafter, simply referred to as a “battery ECU 52”) via inverters 41, 42 and 43, respectively. An electronic control unit 40 for the motors (hereinafter, referred to as a “motor ECU 40”) controls ON/OFF states of switching elements (not shown) of the inverters 41, 42 and 43, thereby controlling the motors MG1, MG2, and MG3, respectively. The motor ECU 40 receives signals necessary for controlling the motors MG1, MG2, and MG3, for example, signals from rotational position detection sensors 44, 45 and 46 that detect the rotational positions of the rotors of the MG1, MG2, and MG3, respectively, and signals indicating phase currents that are applied to the motors MG1, MG2, and MG3 and that are detected by a current sensor (not shown). The motor ECU 40 outputs switching control signals to the inverters 41, 42 and 43. The motor ECU 40 communicates with the hybrid ECU 70. The motor ECU 40 controls the motors MG1, MG2, and MG3 according to the control signals from the hybrid ECU 70, and transmits the data concerning the operating states of the motors MG1, MG2, and MG3 to the hybrid ECU 70 as required.

The hybrid ECU 70 is a microprocessor mainly including a CPU 72. In addition to the CPU 72, the hybrid ECU 70 includes ROM 74 that stores processing programs, RAM 76 that temporarily stores the data, an input port (not shown), an output port (not shown), and a communication port (not shown). The hybrid ECU 70 receives, via the input port, an ignition signal from an ignition switch 80; a signal indicating the sift position SP from a sift position sensor 82 that detects the position of a shift lever 81; a signal indicating the accelerator pedal operation amount Acc from an accelerator pedal position sensor 84 that detects the operation amount of the accelerator pedal 83; a signal indicating the brake pedal position BP from a brake pedal position sensor 86 that detects the operation amount of a brake pedal 85; a signal indicating the vehicle speed V from a vehicle speed sensor 88; and the like. As described above, the hybrid ECU 70 communicates with the engine ECU 24, the motor ECU 40 and the battery ECU 52, via the communication port. The hybrid ECU 70 exchanges various control signals and data with the engine ECU 24, the motor ECU 40 and the battery ECU 52.

In the hybrid vehicle 20 configured according to the embodiment, the required torque that should be output from the vehicle is calculated based on the accelerator pedal operation amount Acc corresponding to the operation amount of the accelerator pedal 83 achieved by the driver and the vehicle speed V, and the engine 22, the motors MG1, MG2 and MG3 are controlled such that the required power corresponding to the required torque is output therefrom. Examples of the operation control modes for the engine 22 and the motors MG1, MG2, and MG3 include the torque conversion operation mode, the charge-discharge operation mode, and the motor operation mode. In the torque conversion operation mode, the engine 22 is controlled such that the power corresponding to the required power is output from the engine 22, and the motors MG1, MG2, and MG3 are controlled such that the torque of the entire power output from the engine 22 is converted by the power split-integration mechanism 30, the motors MG1, and one of or both the motors MG2 and MG3 and then output therefrom. In the charge-discharge operation mode, the engine 22 is controlled such that the power corresponding to the sum of the required power and the electric power required for charging/discharging of the battery 50 is output from the engine 22, and the motors MG1, MG2, and MG3 are controlled such that the torque of the all or part of the power output from the engine 22 due to charging/discharging of the battery 50 is converted by one of or both the power split-integration mechanism 30 and the motors MG1, MG2, and MG3, and the required power is output therefrom. In the motor operation mode, the operation control is performed such that the engine 22 is stopped, and power corresponding to the required power is output from one of or both the motor MG2 and the motor MG3.

The drive unit according to the embodiment includes the two motors MG1 and MG2, the power split-integration mechanism 30, and the reduction gear 35. The input shaft of the drive unit according to the embodiment is the crankshaft 26 connecting the engine 22 to the drive unit via the damper 28, and the drive shaft serving as the output shaft of the drive unit is the rotating shaft of the ring gear 32. In FIG. 1, the rotating shaft is shown as a ring gear shaft 32a indicated by the dashed line.

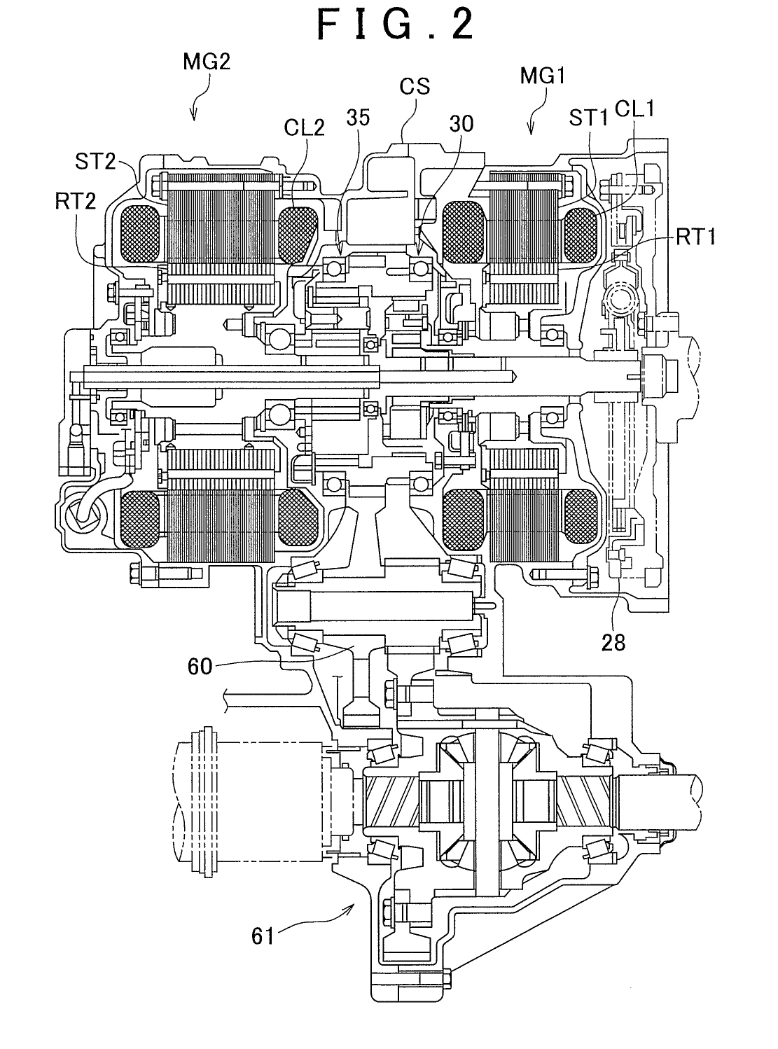

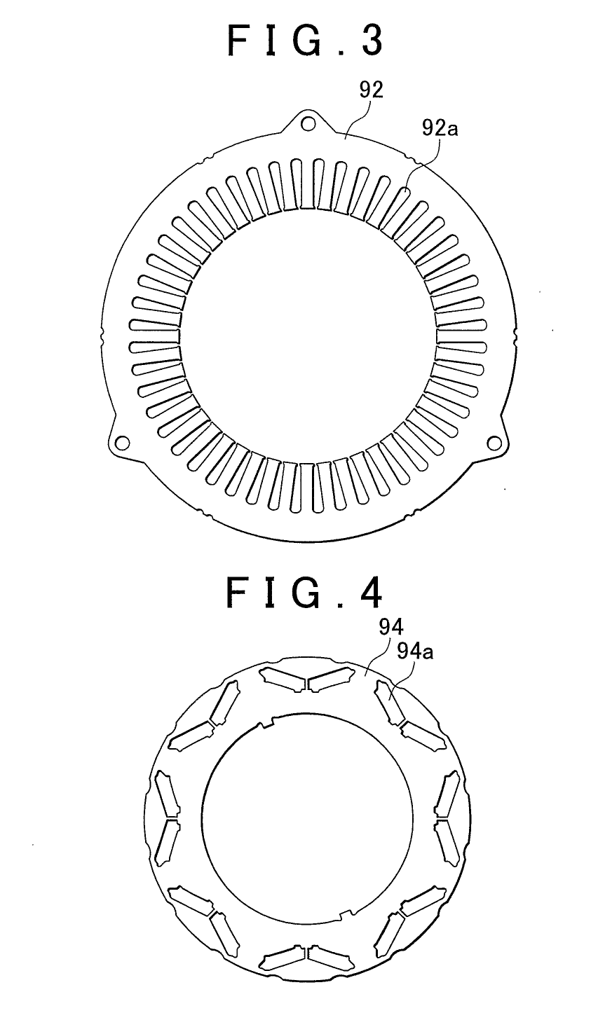

FIG. 2 illustrates an example of the configuration of the drive unit according to the embodiment. As shown in FIG. 2, in the drive unit according to the embodiment, the motor MG1, the power split-integration mechanism 30, the reduction gear 35, and the motor MG2 are coaxially arranged in a single-piece case CS in this order from the right side of the figure. The two motors MG1 and MG2 include stators ST1 and ST2, and the rotors RT1 and RT2, respectively. Each of the stators ST1 and ST2 is formed by stacking multiple stator members 92, shown in FIG. 3, formed by punching out non-oriented magnetic steel sheets. Similarly, each of the rotors RT1 and RT2 is formed by stacking multiple rotor members 94, shown in FIG. 4, formed by punching out non-oriented magnetic steel sheets. Coils CL1 and CL2 are wound around the stator ST1 and ST2, respectively. Permanent magnets (not shown) are attached to the rotors RT1 and RT2. As shown in FIG. 3, in the stator member 92, multiple lots 92a for winding the coils CL1 and CL2 are formed. As shown in FIG. 4, in the rotor member 94, multiple magnet holes 94a into which permanent magnets are fitted are formed. Namely, the motors MG1 and MG2 are assembled from the stator members 92, which are made of the same material and which have the same structure, and the rotor members 94, which are made of the same material and which have the same structure.

In the embodiment, the motors MG1 and MG2 are assembled such that the number of the stator members 92 and the number of the rotor members 94 of the motor MG2 are 1.6 times as large as the number of the stator members 92 and the number of the rotor members 94 of the motor MG1, respectively. Namely, the motors MG1 and MG2 are assembled such that the thickness of the stator ST2 and the rotor RT2 obtained by stacking the stator members 92 and the rotor members 94 is 1.6 times as large as the thickness of stator ST1 and the rotor RT1 obtained by stacking the stator members 92 and the rotor members 94. This is because the output features are different between the motor MG1 and the motor MG2. In each of the above-mentioned operation modes, the motor MG1 serves mainly as a generator to adjust the speed of the engine 22 and output part of the power from the engine 22 to the front wheels 62a and 62b side. On the other hand, the motor MG2 serves mainly as an electric motor to output the power to the front wheels 62a and 62b side. Accordingly, the motor MG1 should have the output features suitable for a generator, and the motor MG2 should have the output features suitable for an electric motor.

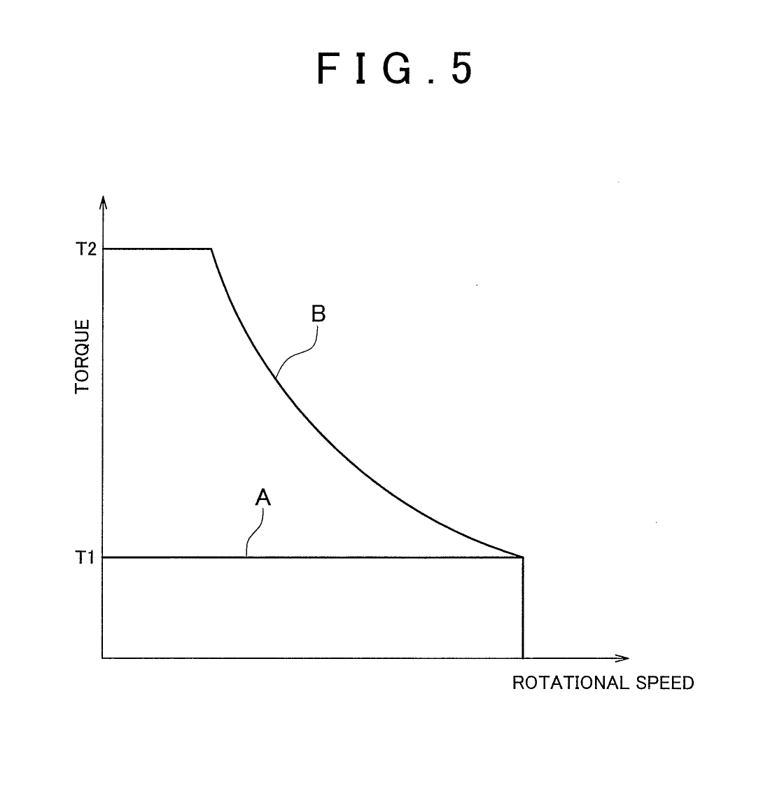

FIG. 5 shows an example of the output features of the motors MG1 and MG2 according to the embodiment. In FIG. 5, the range indicated by the straight line A corresponds to the output features of the motor MG1, and the range indicated by the line B, where a part is a straight line and the other part is a curved line, corresponds to the output features of the motor MG2. In the embodiment, as shown in FIG. 5, the maximum torque of the motor MG2 is approximately four times as high as the maximum torque of the motor MG1 in the region where the rotational speed is low. The torque of the motor is determined based on the product of the rotor magnetic flux and the electric current. Because the motors MG1 and MG2 are assembled from the rotors and the stators, that, respectively have the same diameter, the superficial area of the rotor of the motor MG2 needs to be 1.6 times as large as the superficial area of the rotor of the motor MG1 in order to have the motor MG2 output four times the toque of the motor MG1. Accordingly, the thickness of the stator ST2 and the rotor RT2 of the motor MG2 is made 1.6 times as thick as the stator ST1 and the rotor RT1 of the motor MG1. Thus, both the motor MG1 and the motor MG2, which have the different output features, can be assembled from the same stator members 92 and the same rotor members 94.

In the two motors MG1 and MG2 according to the embodiment, the stators ST1 and ST2 can be assembled from the same components (the stator members 92) and the rotors RT1 and RT2 can be assembled from the same components (the rotor members 94). In addition, in the two motors MG1 and MG2, the coils CL1 and CL2 are made of the same material and have the same cross sectional shape, permanent magnets are made of the same material, have the same cross sectional shape, and are provided with the same surface treatment. Making part of configurations, namely, the main configurations of the motors MG1 and MG2 according to the same design specifications reduces the variety of the components constituting the motors MG1 and MG2, and improves the efficiency in the assembly and production of the motors MG1 and MG2. Also, because the same members are produced in large numbers, the members can be produced with high accuracy, and quality of the motors MG1 and MG2 produced is more consistent. In addition, as shown in FIG. 2, because the motors MG1 and MG2 having the same diameter are housed in the single-piece case CS with the power split-integration mechanism 30 and the reduction gear 35 provided therebetween, the drive unit can be made compact, and the drive unit can be mounted in the vehicle more easily.

In the drive unit included in the hybrid vehicle 20 according to the embodiment described above, part of configurations (the main configurations) of the motors MG1 and MG2 is made according to the same design specifications. Accordingly, the variety of the components constituting the motors MG1 and MG2 is reduced, and the efficiency in the assembly and production of the motors MG1 and MG2 is improved. Also, because the same members are produced in large numbers, the stator members 92 and the rotor members 94 can be produced with high accuracy, and quality of the motors MG1 and MG2 produced is more consistent. In addition, because the motors MG1 and MG2 are housed in the single-piece case CS with the power split-integration mechanism 30 and the reduction gear 35 provided therebetween, the drive unit can be made compact, and the drive unit can be mounted in the vehicle more easily.

In the drive unit according to the embodiment, the motor MG1 and the motor MG2 having different output features are assembled from the same stator members 92, which are made of the same material, which have the same configuration, and which have the same diameter, and the same rotor members 94, which are made of the same material, which have the same configuration, and which have the same diameter, the coils CL1 and CL2, which are made of the same material and which have the same cross sectional shape, and the permanent magnets which are provided with the same surface treatment. However, all of these components need not be the same in the motor MG1 and the motor MG2. For example, the configurations of the coils CL1 and CL2 and the permanent magnets may be made according to the particular specifications for each of the motor MG1 and the motor MG2. Alternatively, the stator members 92 and the rotor members 94 may be made of materials different between the motor MG1 and the motor MG2.

The drive unit according to the embodiment includes the two motors MG1 and MG2, the power split-integration mechanism 30, and the reduction gear 35, and the motors MG1 and MG2 are housed in the single-piece case CS with the power split-integration mechanism 30 and the reduction gear 35 provided therebetween. However, when the drive unit includes the two motors MG1 and MG2 and the power split-integration mechanism 30, the motors MG1 and MG2 may be housed in the single-piece case CS with the power split-integration mechanism 30 provided therebetween. Namely, the reduction gear 35 need not be provided. Alternatively, a speed-up gear or a reduction gear that changes the shift speed may be provided instead of the reduction gear 35.

In the hybrid vehicle 20 according to the embodiment, part of configurations of the motors MG1 and MG2 may be made according to the same design specifications. In addition, part of the configurations of the motor MG3 may be made according to the same design specifications as those of the motors MG1 and MG2. Thus, the variety of components constituting the motors MG1, MG2, and MG3 can be reduced, and the efficiency in the assembly and production of the motors MG1, MG2 and MG3 can be improved. Part of the configurations of the motors MG1 and MG3 may be made according to the same design specifications, and the configurations of the motor MG2 may be made according to the design specifications different from those of the motors MG1 and MG3. Alternatively, part of the configurations of the motors MG2 and MG3 may be made according to the same design specifications, and the configurations of the motor MG1 may be made according to the design specifications different from those of the motors MG2 and MG3.

In the hybrid vehicle 20 according to the embodiment, in addition to the motors MG1 and MG2, the motor MG3 for driving the rear wheels 64a and 64b are provided. However, provision of the motor MG3 is optional.

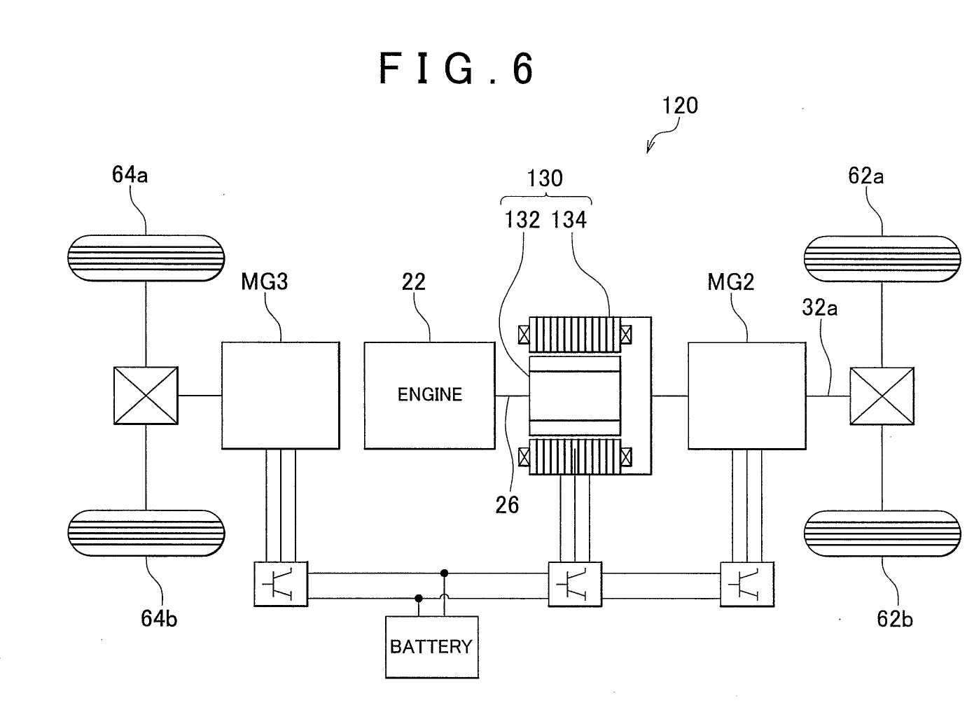

In the hybrid vehicle 20 according to the embodiment, the power from the engine 22 is output to the ring gear 32 (the ring gear shaft 32a serving as the drive shaft) connected to the front wheels 62a and 62b via the power split-integration mechanism 30. However, as shown in a hybrid vehicle 120 according to a modified example shown in FIG. 6, there may be provided an electric motor 130 for a rotor that includes an inner rotor 132 connected to the crankshaft 26 of the engine 22 and an outer rotor 134 connected to the drive shaft that outputs power to the front wheels 62a and 62b, and that transmits part of the power from the engine 22 to the drive shaft and converts the remaining power into electric power. In this case, the configurations of two or all of the motor MG2, the motor MG3, and the electric motor 130 for a rotor are made according to the same design specifications.

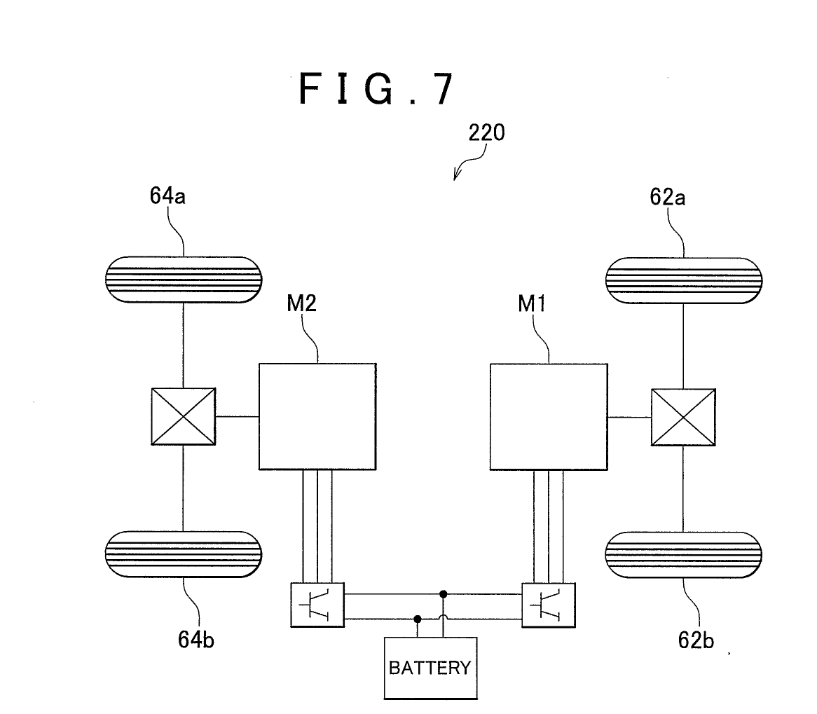

In the embodiment, the invention is applied to the hybrid vehicle 20 including the engine 22, and the motors MG1, MG2 and MG3 that are driven by the inverters 41, 42 and 43, respectively. However, application of the invention is not limited to hybrid vehicles. In another modified example of the invention, as shown FIG. 7, a vehicle 220 includes the motor M1 that outputs power to the front wheels 62a and 62b and the motor M2 that outputs power to the rear wheels 64a and 64b, but does not include an engine. In this case, part of configurations of the motor M1 and the motor M2 is made according to the same design specifications.

In the embodiment, the drive unit is mounted in the hybrid vehicle 20. However, the drive unit may be mounted in moving bodies other than vehicles, such as vessels and aircraft. Also, the drive unit may be embedded, for example, in immovable construction equipment.

The embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein. Also, the invention can be applied to the industry for producing the drive units and vehicles.

1. A drive unit that includes a plurality of rotary electric devices that are used to output different amounts of power, the drive unit comprising:
at least two of the plurality of rotary electric devices that are constructed such that a stator and a rotor of the at least two rotary electric devices comprises stator members and rotor members of identical shape diameter, respectively, wherein
the stator of each of the plurality of rotary electric devices is formed by stacking multiple stator members,
the rotor of each of the plurality of rotary electric devices is formed by stacking multiple rotor members; and
the stator members and the rotor members of the at least two rotary electric devices differ in the number of the stator members stacked and the number of the rotor members stacked, respectively, such that the at least two rotary electric devices output different amount of power.

2. The drive unit according to claim 1, wherein
the stator members and the rotor members of the corresponding rotary electric devices are made of the same material and have the same structure, respectively.

3. The drive unit according to claim 1, wherein
at least two of the corresponding rotary electric devices (MG3) are housed in a single-piece case.

4. A vehicle including the drive unit according to claim 1 that is used to output power to run the vehicle.

5. The vehicle according to claim 4, wherein
the corresponding rotary electric devices include the first rotary electric device that is used to output power to a first axle and the second rotary electric device that is used to output power to a second axle that differs from the first axle.

6. The drive unit according to claim 1, further comprising:
a tri-axial power transfer device that is connected to three shafts, which are an input shaft that can receive and output power, a drive shaft that can output power, and a rotating shaft and that outputs power, based on power input in and output from two of the three shafts, to the other shaft, wherein
the corresponding rotary electric devices include the first rotary electric device that inputs power in the rotating shaft Hand the second rotary electric device that inputs power in the drive shaft.

7. The drive unit according to claim 6, wherein
the tri-axial power transfer means is provided between the first rotary electric device and the second rotary electric device and the tri-axial power transfer means, the first rotary electric device (MG1), and the second rotary electric device are housed in a single-piece case.

8. The drive unit according to claim 7, wherein
the second rotary electric device is connected to the drive shaft via a reduction gear, and
the reduction gear is provided between the tri-axial power transfer means and the second rotary electric device.

9. A vehicle including the drive unit according to claim 6 and an internal combustion engine, wherein
an output shaft of the internal combustion engine is connected to the input shaft, and
an axle is connected to the drive shaft.

10. The vehicle according to claim 9, further comprising:
a third rotary electric device that comprises a stator which is formed by stacking multiple stator members identical to the stator members of the first and second rotary electric devices in view of shape, diameter, material and structure and a rotor which is formed by stacking multiple rotor members identical to the rotor members of the first and second rotary electric devices in view of shape, diameter, material and structure and which outputs power to an axle different from the axle connected to the drive shaft.

11. The vehicle according to claim 10, wherein
the corresponding rotary electric devices are two of the first rotary electric device, the second rotary electric device, and the third rotary electric device.
